(19) United States
(12) Patent Application Publication
(10) Pub. No.: US 2021/0272166 A1
(43) Pub. Date: Sep. 2, 2021

(54) SYSTEMS AND METHODS FOR ONLINE BONAFIDE LEAD GENERATION

(71) Applicant: Blueprint Nine, LLC, Pittsburgh, PA (US)

(72) Inventors: Kale Abrahamson, Pittsburgh, PA (US); Taylor Hiott, Verona, PA (US)

(21) Appl. No.: 17/025,678

(22) Filed: Sep. 18, 2020

Related U.S. Application Data
(60) Provisional application No. 62/983,219, filed on Feb. 28, 2020.

(51) Int. Cl. G06Q 30/02; G06Q 10/06; G06Q 50/00

(52) U.S. Cl. CPC G06Q 30/0277; G06Q 50/01; G06Q 10/06311; G06Q 30/0245

(57) ABSTRACT

Embodiments of the present disclosure are directed to systems and methods that are configured to identify potential bonafide leads for a particular sales product. The disclosed systems and methods provide an approach to identify potential leads by educating the potential lead on the particular sales product via a video sales letter and at a predetermined elapsed time, allow the potential lead to advance to a survey. The survey assists in determining whether the potential lead meets at least two qualifications that have been selected to maximize the odds that the potential lead will turn into a bonafide lead. Moreover, the disclosed systems and methods transmit data, based on potential leads that may qualify as a bonafide lead, such as characteristic data and demographic data, to improve locating additional potential leads based on similar data and to mine for potential leads and determine whether the potential lead is a bonafide lead.

### CROSS REFERENCE

This application claims priority to the U.S. Provisional Patent Application Ser. No. 62/983,219, filed on Feb. 28, 2020, and entitled “Systems and Methods for Online Bonafide Lead Generation” which is incorporated by reference herein in its entirety under 35 U.S.C. 119(e).

### TECHNICAL FIELD

The present disclosure generally relates to a sales practice and, more particularly, to systems and methods for identifying a bonafide lead for a particular sales product.

### BACKGROUND

The internet has expanded a potential customer base. As such, new marketing and advertising methods are used to capture the attention of potential customers. Further, once a potential customer attention is captured, the potential customer must be sold on the idea or product before turning the potential customer into a customer. Companies spend enormous amounts of money to determine whether a potential customer may be a bonafide lead that will turn into a paying customer. One way of attracting potential customers is through video sales letters (VSL). Another way is to use paid social media advertising to attract leads into the VSL funnel to watch the video sales letter. However, these do not weed out potential customers who are not ready to commit to purchasing the idea or product (i.e., not a bonafide lead) and do not provide feedback to the sales team who ultimately has to sell the idea or product to the bonafide lead.

### SUMMARY

In one embodiment, a method for determining a bonafide lead is provided. The method includes displaying an advertisement on a third party webpage, receiving, from a user client device, a selection of a type of first response action from a user, directing the user client device to a first webpage based on the first type of response action received from the user, querying a unique identifier from the user, and playing a video sales letter directed to the user. The method continues by displaying a graphic to appear to the user after a predetermined amount of time of the playing of the video sales letter directed to the user has elapsed, activating, by the user, the graphic, directing the user client device to a second webpage based on the activating of the graphic by the user, querying, via a first survey question, a second type of response action, and querying, via a second survey question, a third type of response action. The method continues by directing the user client device to a third webpage based on the second and third response action received from the user, wherein the third webpage receives a qualified user to display a first plurality of sales packages and to elicit a teleconference with a sales representative, scheduling a communication with the sales representative within a predetermined time frame based on a time when the user client device is directed to the third webpage, and directing the user client device to a fourth webpage after the qualified user has scheduled the conference call wherein, the fourth webpage includes a plurality of hidden pixels that track the qualified user and a plurality of predetermined demographic and characteristics information about the qualified user such that the advertisement on the third party webpage may target a plurality of target potential users with similar demographic and characteristics at a future point in time.

In another embodiment, a system for determining a bonafide lead is provided. The system includes a processing device and a non-transitory, processor-readable storage medium in communication with the processing device, the non-transitory, processor-readable storage medium comprising one or more programming instructions that, when executed, cause the processing device to display, on a user client device, an advertisement on a third party webpage, receive, from the user client device, a selection of a type of first response action from a user, direct, the user client device, to a first webpage based on the first type of response action received from the user and query, on the user client device, a unique identifier from the user. Further, the non-transitory, processor-readable storage medium comprising one or more programming instructions that, when executed, cause the processing device to play, on the user client device, a video sales letter directed to the user, display, on the user client device, a graphic to appear to the user after a predetermined amount of time of the playing of the video sales letter directed to the user has elapsed, activate, by the user on the user client device, the graphic, direct the user client device to a second webpage based on the activating of the graphic by the user, query, via a first survey question, a second type of response action, and query, via a second survey question, a third type of response action. The non-transitory, processor-readable storage medium comprising one or more programming instructions that, when executed, cause the processing device to direct the user client device to a third webpage based on the second and third response action received from the user, wherein the third webpage receives a qualified user to display a first plurality of sales packages and to elicit a teleconference with a sales representative, schedule a communication with the sales representative within a predetermined time frame based on a time when the user client device is directed to the third webpage, and direct the user client device to a fourth webpage after the user has scheduled the conference call wherein, the fourth webpage includes a plurality of hidden pixels that track the user and a plurality of predetermined demographic and characteristics information about the user such that the advertisement on the third party webpage may target a plurality of target potential users with similar demographic and characteristics at a future point in time.

In another embodiment, a method for determining a bonafide lead is provided. The method includes displaying an advertisement on a third party webpage, receiving, from a user client device, a selection of a type of first response action from a user, directing the user client device to a first webpage based on the first type of response action received from the user, querying a unique identifier from the user, and playing a video sales letter directed to the user. The method continues by displaying a graphic to appear to the user after a predetermined amount of time of the playing of the video sales letter directed to the user has elapsed, activating, by the user, the graphic, directing the user client device to a second webpage based on the activating of the graphic by the user, querying, via a first survey question, a second type of response action, and querying, via a second survey question, a third type of response action. The method continues by determining whether the second and third response action received from the user meet a predetermined threshold, directing the user client device to a third webpage based on the second and third response action received from the user meets the predetermined threshold, wherein the third webpage receives a qualified user to display a first plurality of sales packages and to elicit a teleconference with a sales representative, scheduling a communication with the sales representative within a predetermined time frame based on a time when the user client device is directed to the third webpage, and directing the user client device to a fourth webpage after the qualified user has scheduled the conference call. The fourth webpage includes a customized video for the qualified user. The method continues by directing the user client device to a fifth webpage after the qualified user has completed the customized video. The fifth webpage includes a plurality of hidden pixels that track the qualified user and a plurality of predetermined demographic and characteristics information about the qualified user such that the advertisement on the third party webpage may target a plurality of target potential users with similar demographic and characteristics at a future point in time.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a system for identifying a bonafide lead for a particular sales product according to one or more embodiments described and illustrated herein;

FIG. 2A schematically depicts an interface device from FIG. 1, further illustrating hardware and software components that may be used to identify a bonafide lead according to one or more embodiments described and illustrated herein;

FIG. 2B schematically depicts a user computing device from FIG. 1, further illustrating hardware and software components that may be used to identify a bonafide lead according to one or more embodiments described and illustrated herein;

FIG. 2C schematically depicts a sales member computing device from FIG. 1, further illustrating hardware and software components that may be used to identify a bonafide lead according to one or more embodiments described and illustrated herein;

FIG. 3A depicts a flow diagram of an illustrative method of identifying a bonafide lead according to one or more embodiments shown and described herein;

FIG. 3B depicts a continuation of a flow diagram of the illustrative method of FIG. 3A identifying a bonafide lead according to one or more embodiments shown and described herein;

FIG. 3C depicts a flow diagram of an illustrative method of directing a potential client to an alternative sales package according to one or more embodiments shown and described herein;

FIG. 3D depicts a flow diagram of a second embodiment of an illustrative method directing a potential lead to an alternative sales package according to one or more embodiments shown and described herein;

FIG. 4 schematically depicts an illustrative view of a landing webpage eliciting a unique identifier from a potential bonafide lead according to one or more embodiments shown and described herein;

FIG. 5 schematically depicts an illustrative view of a video sales letter webpage displaying a video sales letter with a delayed graphic according to one or more embodiments shown and described herein;

FIG. 6A schematically depicts an illustrative view of a survey webpage displaying a first portion of a survey questionnaire that elicits an age from the potential bonafide lead according to one or more embodiments shown and described herein;

FIG. 6B schematically depicts an illustrative view of the survey webpage displaying a second portion of the survey questionnaire of FIG. 6A that elicits a monetary investment amount from the potential bonafide lead according to one or more embodiments shown and described herein; and

FIG. 7 schematically depicts an illustrative view of a webpage displaying a sales call schedule displayed within a predetermined range of time according to one or more embodiments shown and described herein.

### DETAILED DESCRIPTION

Embodiments of the present disclosure are directed to systems and methods to identify potential bonafide leads for a particular sales product. More specifically, the disclosed systems and methods provide an approach to identify potential leads by educating the potential lead on the particular sales product via a video sales letter and at a predetermined elapsed time, allow the potential lead to advance to a survey. The survey assists in determining whether the potential lead meets at least two qualifications that have been selected to maximize the odds that the potential lead will turn into a bonafide lead. Conventionally, users click on an ad or watch a video, input contact information and wait for a phone call or e-mail from a sales team member. However, this is costly in both money and time to spend on potential leads who are either not interested in the specific sales product and/or do not have the qualifications required to purchase the specific sales product.

Traditionally, sales people rely on word of mouth or are limited to sales lists or other third party databases that cost additional money for leads that may or may not have certain characteristics and demographics. That is, existing computer systems merely allow a sales person to search for generalized potential leads. The results returned merely show a generalized group of potential leads. As such, it would be incumbent upon the user to determine whether any of the generalized leads may actually qualify as a bonafide lead. This can be a time consuming and inaccurate process, particularly in instances where the user is unaware of certain characteristics and/or demographics of a generalized pool of potential leads. As such, the specialized systems and methods described herein are particularly configured to determine potential leads based on known characteristic and/or demographic information from known bonafide leads based on the processes described herein. In addition, the systems and methods described herein provide a particular improvement in the way that data is collected and analyzed for potential lead generation and bonafide lead determination.

As used herein a “bonafide lead” means a potential customer who has been screened and meets a plurality of predetermined requirements and has interest in a particular sales product. For example, the bonafide lead may be over 18 years of age and have a predetermined amount of discretionary income to invest in a certain sales training or particular sales product. Further, the bonafide lead may have already been introduced to the sales item via a variety of methods including video sales letters and the like.

As used herein a “potential lead” and/or “user” means a potential client or person that may have an interest but has not yet been screened to determine whether or not the potential client or user meets a plurality of predetermined criteria to qualify for the particular product or service. For example, a paying student of a training product.

Various systems and methods for identifying bonafide leads are described in detail herein.

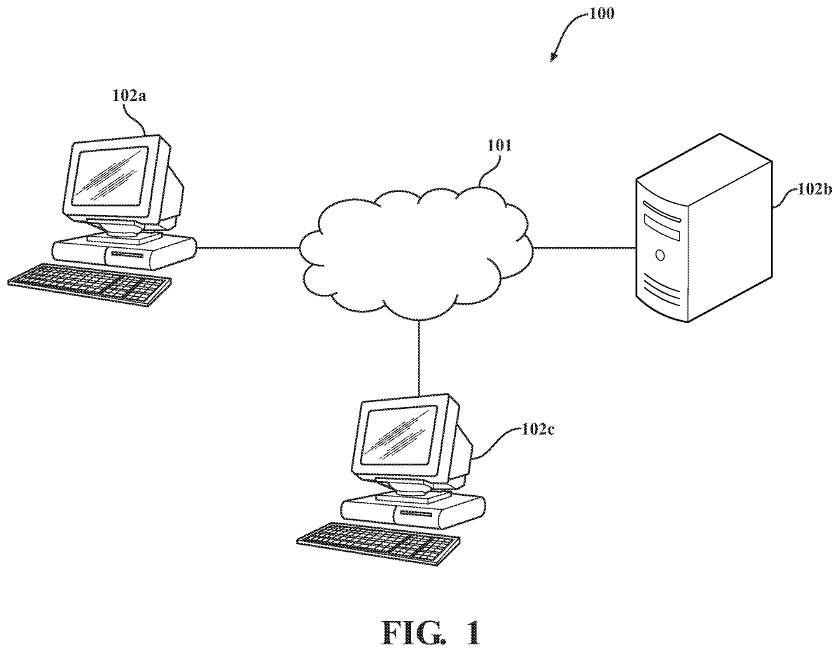

Referring now to the drawings, FIG. 1 depicts an illustrative computing network that depicts components for a system 100 for interacting with a potential lead to identify whether the potential lead is a bonafide lead, according to embodiments shown and described herein. As illustrated in FIG. 1, a computer network 101 may include a wide area network (WAN), such as the internet, a local area network (LAN), a mobile communications network, a public service telephone network (PSTN) a personal area network (PAN), a metropolitan area network (MAN), a virtual private network (VPN), and/or another network. The computer network 101 may generally be configured to electronically connect one or more computing devices and/or components thereof. Illustrative computing devices may include, but are not limited to, a user computing device 102a, an interface device 102b, and a sales team computing device 102c.

The user computing device 102a may generally provide an interface between a user and the other components connected to the computer network 101. Thus, the user computing device 102a may be used to perform one or more user-facing functions, such as receiving one or more inputs from a user or transmitting data or information such as data related to inputting personal information, viewing videos, taking a survey, and the like. More specifically, to perform an electronic search query, the user computing device 102a may present a user with a user interface that allows the user to view a video sales letter, to enter answers to one or more survey questions, and to schedule a sales call. The user interface may be configured to receive a video sales letter, survey questions, and/or schedule the sales call from the interface device 102b and utilize data received from the interface device 102b when displaying the video sales letter, the survey questions and/or the schedule for the sales call, as described in greater detail herein. The video sales letter may include a hidden button that only appears for the user to advance after a predetermined amount of time of the video sales letter has elapsed. Further, the user is directed to different webpages in the process depending on the user's answers to the survey questions. The components and functionality of the user computing device 102a will be set forth in detail below.

Additionally, included in FIG. 1 is the sales team computing device 102c. In the event that the interface device 102b requires oversight, updating, or correction, the sales team computing device 102c may be configured to provide the desired oversight, updating, and/or correction. The sales team computing device 102c may also be used to input additional data into a data storage portion of the interface device 102b. For example, the sales team computing device 102c may input availability of sales team members for scheduling the sales call. Further, the sales team computing device 102c may receive data from interface device 102b, such as the user's answers to the survey questions, the scheduled sales call, the unique identifier of the user and the like.

The interface device 102b may determine specific characteristics and demographics of previous bonafide leads to attempt to capture new potential leads based on matching or similar specific characteristics and demographics. For instance, potential leads in specific regions of the world may have the same disposable income to invest in a specific sales product. As such, the interface device 102b may also determine potential leads to identify bonafide leads based on common occupations, ages, public information, and the like. The interface device 102b may also transmit information to the user computing device 102a such that the user computing device 102a may display the video sales letter, initiate the appearing of the button link to continue, provide the survey, and direct the user to next webpage in the process based on the answers to the survey. The interface device 102b may provide or transmit data to an external device, such as the user computing device 102a, to display information such as click advertisements tailored to specific potential leads that meet the similar specific characteristics and demographics. The components and functionality of the interface device 102b will be set forth in detail below.

It should be understood that while the user computing device 102a and the sales team computing device 102c are depicted as personal computers and the interface device 102b is depicted as a server, these are merely examples. More specifically, in some embodiments, any type of computing device (e.g., mobile computing device, personal computer, server, and the like) may be utilized for any of these components. Additionally, while each of these computing devices is illustrated in FIG. 1 as a single piece of hardware, this is also an example. More specifically, each of the user computing device 102a, the interface device 102b, and the sales team computing device 102c may represent a plurality of computers, servers, databases, and the like.

In addition, it should be understood that while the embodiments depicted herein refer to a network of computing devices, the present disclosure is not solely limited to such a network. For example, in some embodiments, the various processes described herein may be completed by a single computing device, such as a non-networked computing device or a networked computing device that does not use the network to complete the various processes described herein.

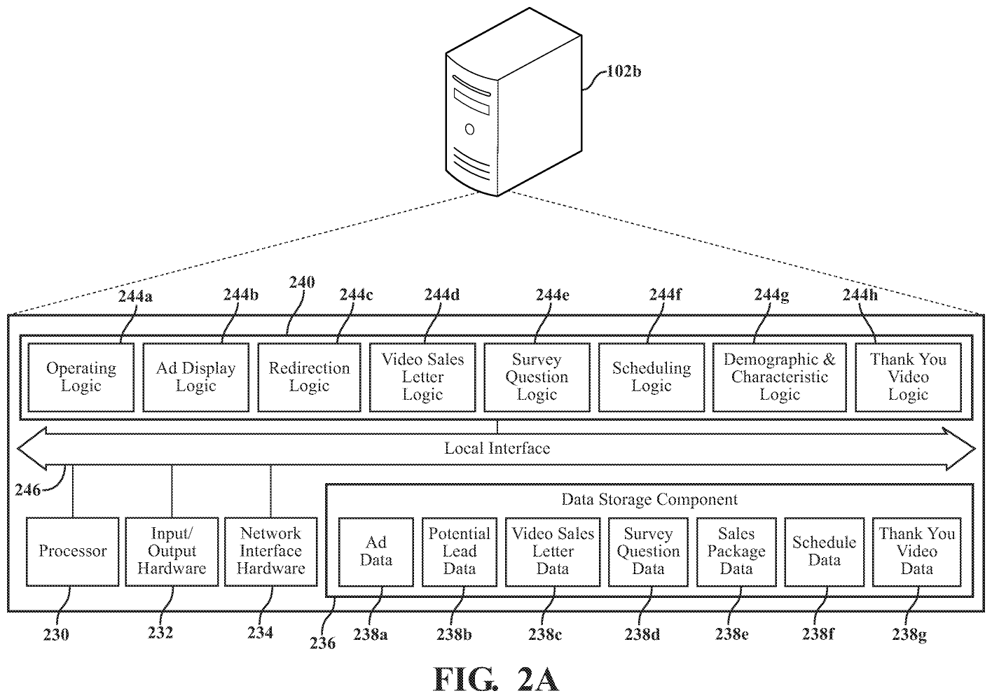

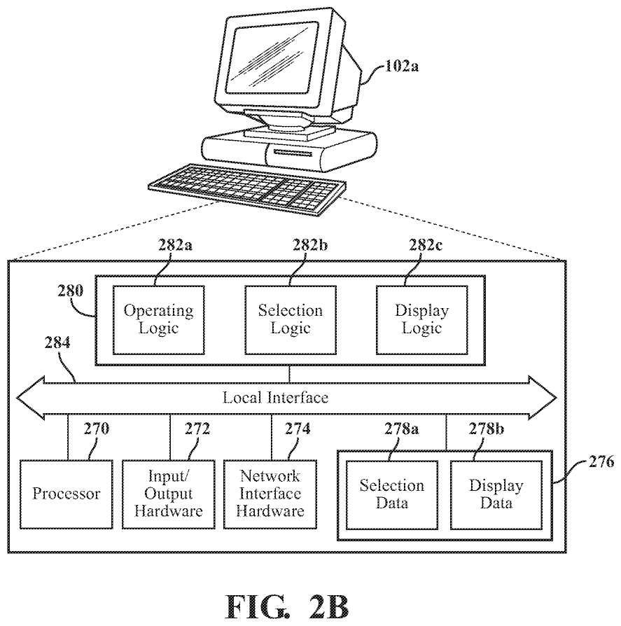

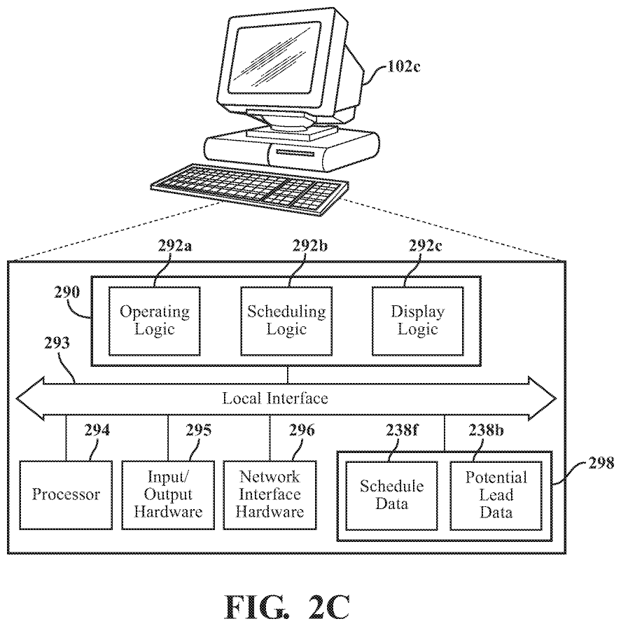

FIG. 2A depicts the interface device 102b, further illustrating a system that identifies a bonafide lead for a specific sales product by utilizing hardware, software, and/or firmware, according to embodiments shown and described herein. The interface device 102b may include a non-transitory, computer readable medium configured for identifying potential leads, identifying bonafide leads, and/or the like embodied as hardware, software, and/or firmware, according to embodiments shown and described herein.

While in some embodiments, the interface device 102b may be configured as a general purpose computer with the requisite hardware, software, and/or firmware, in other embodiments, the interface device 102b may be configured as a special purpose computer designed specifically for performing the functionality described herein. For example, the interface device 102b may be a specialized device that particularly identifies whether the potential lead is a bonafide lead based on predetermined criteria, rules, and/or the like. In a further example, the interface device 102b may be a specialized device that determines potential leads based on characteristics and demographics of known bonafide leads and generates a data list to identify a plurality of potential leads. The interface device 102b then targets the plurality of potential leads by pushing specific advertisements and other methods known to those skilled in the art to an external component (e.g., the user computing device 102a (FIG. 1)) for the purposes of identifying whether any of the plurality of potential leads are bonafide leads, which then thereby improves the pool of the plurality potential leads using the characteristics and demographics of the newly known bonafide leads.

As also illustrated in FIG. 2A, the interface device 102b may include a processor 230, input/output hardware 232, network interface hardware 234, a data storage component 236, which stores an advertisement data 238a, potential lead data 238b, video sales letter data 238c, survey question data 238d, sales package data 238e, a schedule data 238f, a thank you video data 238g, and a memory component 240. The memory component 240 may be non-transitory computer readable memory. The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 244a, advertisement display logic 244b, redirection logic 244c, video sales letter logic 244d, survey question logic 244e, scheduling logic 244f, and demographic and characteristic logic 244g and thank you video logic 244h (each of which may be embodied as a computer program, firmware, or hardware, as an example). A local interface 246 is also included in FIG. 2A and may be implemented as a bus or other interface to facilitate communication among the components of the interface device 102b. It should be understood that the processor 230, memory component 240 and various logic modules such as advertisement display logic 244b, redirection logic 244c, video sales letter logic 244d, survey question logic 244e, scheduling logic 244f, and demographic and characteristic logic 244g, and the thank you video logic 244h may define a computer-program product for identifying potential leads and/or bonafide leads for a particular sales product.

The processor 230 may include any processing component(s) configured to receive and execute instructions (such as from the data storage component 236 and/or memory component 240). The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, wireless fidelity (Wi-Fi) card, WiMax card, mobile communications hardware, and/or other hardware for communicating with other networks and/or devices.

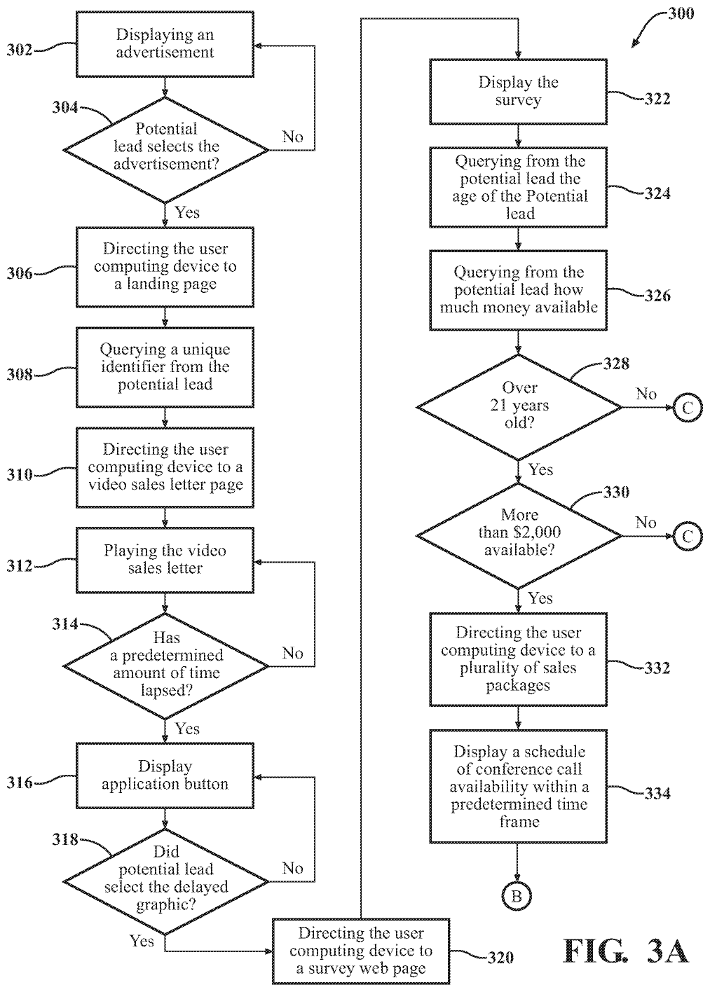

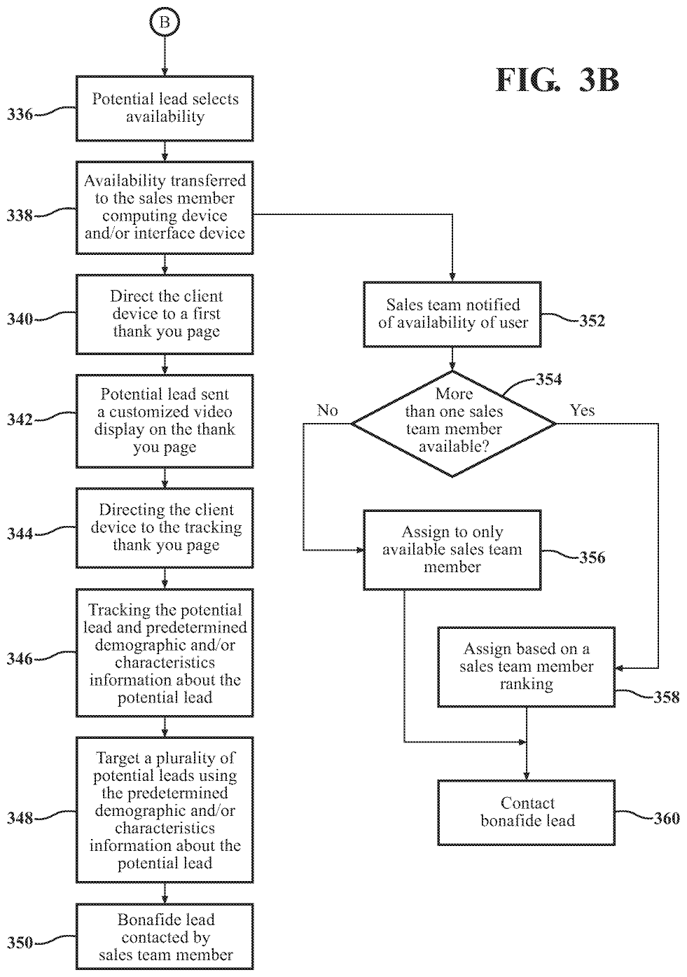

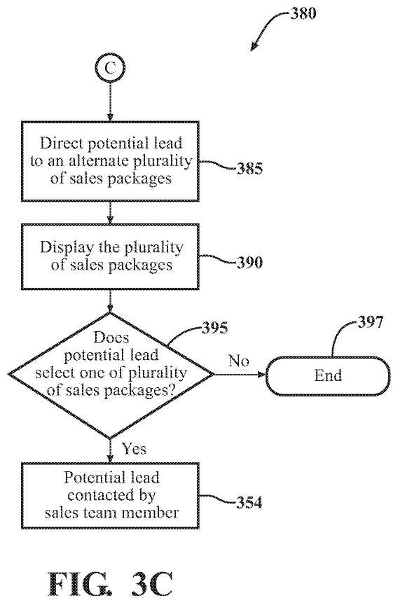

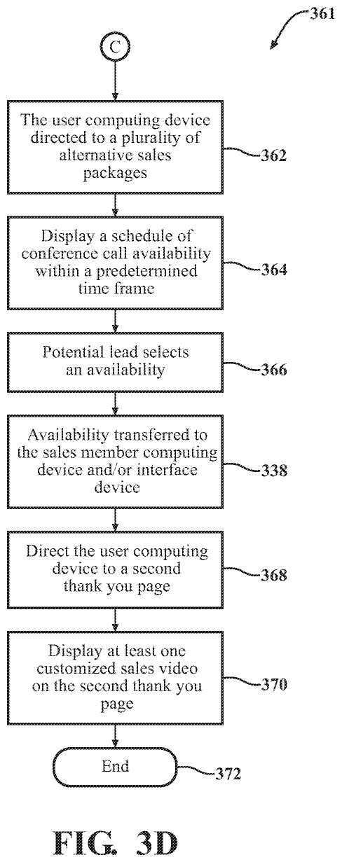

It should be understood that the data storage component 236 may reside local to and/or remote from the interface device 102b and may be configured to store one or more pieces of data for access by the interface device 102b and/or other components, determine the plurality of potential leads, and/or identify a bonafide lead and the characteristics and demographic of each bonafide lead. As illustrated in FIG. 2A, the data storage component 236 stores a plurality of advertisement data 238a. As mentioned above, the plurality of advertisement data 238a may include the demographics and characteristics information of known bonafide leads (i.e., income, disposable income, region based on IP address, and/or the like) that have been organized and indexed for to display to potential leads who meet a plurality of predetermined criteria (i.e., similar region based on IP, and/or the like), as discussed in greater detail herein. The potential lead data 238b stores potential lead data such as the unique identifier from the potential lead. Further, the potential lead data 238b may store known information from bonafide leads that may be used to identify potential leads and thus to tailor advertisements and other methods known to those skilled in the art to elicit the potential lead into the process described herein with respect to FIGS. 3A-3C. For example, potential leads may be identified by common income ranges to bonafide leads, common disposable income ranges, common regions based on IP address, and/or the like. These common characteristics and/or demographics of potential leads and bonafide leads are indicators that the potential lead may qualify as a bonafide lead. The video sales letter data 238c may contain data relating to the specific sales product and include data to inform the potential lead about the specific sales product as well as to elicit the potential lead to the survey question. Further, the video sales letter data 238c may include the timing of when the delayed graphic, for example a button, appears following a predetermined amount of time elapsing in the video sales letter.

The survey question data 238d may include a plurality of specific inquiries that are asked of the potential lead. The plurality of specific inquiries may include generic questions such as the potential leads name, address, phone number and the like and stores the potential leads responses thereto. In some embodiments, the survey question data 238d may further include specific questions to identify, based on the potential leads answers, whether the potential leads may advance to a schedule a sales call or be redirected to alternative sales products. In some embodiments, one of the specific question to identify whether the potential lead may be a bonafide lead asks the potential lead to indicate “How much money, cash+credit, do you have access to in order to start or grow an online business?” The choices are 1.) “More than $10,000”; 2.) “$5,000-$10,000”; 3.) “$2,000-$5,000” and/or 4.) “Less than $2,000”. It should be appreciated that these specific ranges have been determined as ranges that elicit the potential lead into continuing in the process, opportunity to access purchasing funds and willing to make the investment, answering the sales call, and the like. Further, these ranges may assist in determining the characteristic and/or demographic data of the potential lead. As such, these specific ranges are known to provide the best opportunity into determining and identifying whether the potential lead is a bonafide lead. In other embodiments, another specific question to identify whether the potential lead may be a bonafide lead asks the potential lead to indicate “What is your age?” The choices are 1.) “Under 21”; 2.) “21-29”; 3.) “30-39”; 4.) “40-49” and/or “50-59”. It should be appreciated that these specific ranges have been determined as ranges that weed out potential leads that are not old enough and assist in determining the characteristic and/or demographic data of the potential lead. Further, the should be appreciated that these specific ranges elicit the potential lead into continuing in the process, opportunity to access purchasing funds and willing to make the investment, answering the sales call, and the like. As such, these specific ranges are known to provide the best opportunity into determining and identifying whether the potential lead is a bonafide lead.

The sales package data 238e may include data relating to the specific products for sale. It should be appreciated that there may be a plurality of sales packages. For example, at least one of the plurality of sales packages may be the specific sales product discussed in the video sales letter. In another non-limiting example, one of the plurality of sales packages may include alternative specific sales packages that are catered to each potential lead based on the responses to the survey questions. For example, if the potential lead does not have an initial investment, the potential lead may be directed to alternative options for specific sales products. In another non-limiting example, if the potential lead has more of an initial investment, the potential lead may be directed to alternative options for specific sales products that are more expensive. The schedule data 238f includes available periods within a predetermined amount of time. For example, the predetermined amount of time may be 30 minutes from the potential lead accessing the schedule page up to 24 hours later. In another example, the available predetermined amount of time may be 30 minutes from the potential lead accessing the schedule page up to 48 hours later. It should be appreciated that these specific ranges elicit the potential lead into continuing in the process. That is, the potential lead is still interested in the specific sales product and is less likely to not answer the sales call when the sales call is made within the illustrative ranges discussed herein. As such, these specific ranges are known to provide the best opportunity into determining and identifying whether the potential lead is a bonafide lead. Further, the schedule data 238f stores the user selected time period for the sales call.

The thank you video data 238g may include data relating to the specific thank you videos that are automatically played once it is determined whether the potential lead qualifies as a bonafide lead or is directed to the alternative sales packages. As such, the data stored may include data for a first thank you video and data for a second thank you video. The first video is intended to reinforce the sales relationship for the boanfide lead. The second video is intended to continue to sell the product and inform the potential lead of alternative products that may meet their specific situation (i.e., money to invest). The second video is motivation to continue and if, possible, spend more for the full product, but if not, still close the sale for an alternative sales product from the potential lead.

Further, the thank you video data 238g may include data as to the name of the recipient of the thank you video and a plurality of data related to every name and variant of name to match a saved recorded name to that of the recipient. For example, the name “Erin” may be recorded only once and used whenever the recipient of the first or second video name is “Erin”. Further variants of “Erin” are automatically determined to automatically be added to the video. Such variants may include, for example, “Erinn”, “Arryn”, “Anon”. “Aaron”, “Aron” and the like. As such, only a root name needs to be recorded one time and the system will recognize the variant and initiate the video with the prerecorded name to customize or personalize each video regardless of whether the video is the first or second thank you video.

Included in the memory component 240 are the operating logic 244a, advertisement display logic 244b, redirection logic 244c, video sales letter logic 244d, survey question logic 244e, scheduling logic 244f, demographic and characteristic logic 244g. The operating logic 244a may include an operating system and/or other software for managing components of the interface device 102b. The advertisement display logic 244b may contain programming instructions to facilitate and/or elicit potential leads to click on the ad and funnel, or redirect, into the video sales letter, as described in greater detail herein. The advertisement display logic 244b may use information and/or data from known bonafide leads, such as demographic and/or characteristic data, to display on advertisements to potential leads who may share or have in common demographic and/or characteristic data to those known bonafide leads. It should be appreciated that the advertisement display logic 244b may use social media platforms, search engines, and the like to display the advertisements. As such, the advertisement display logic 244b may transmit data to the receiving computer (i.e., the user computing device 102a) so that the receiving computer displays the advertisements based on the determination of a potential lead, as discussed in greater detail herein. As such, the receiving computer (i.e., the user computing device 102a) has information that triggers the receiving computer to display the advertisements so a user may see and click on the advertisement.

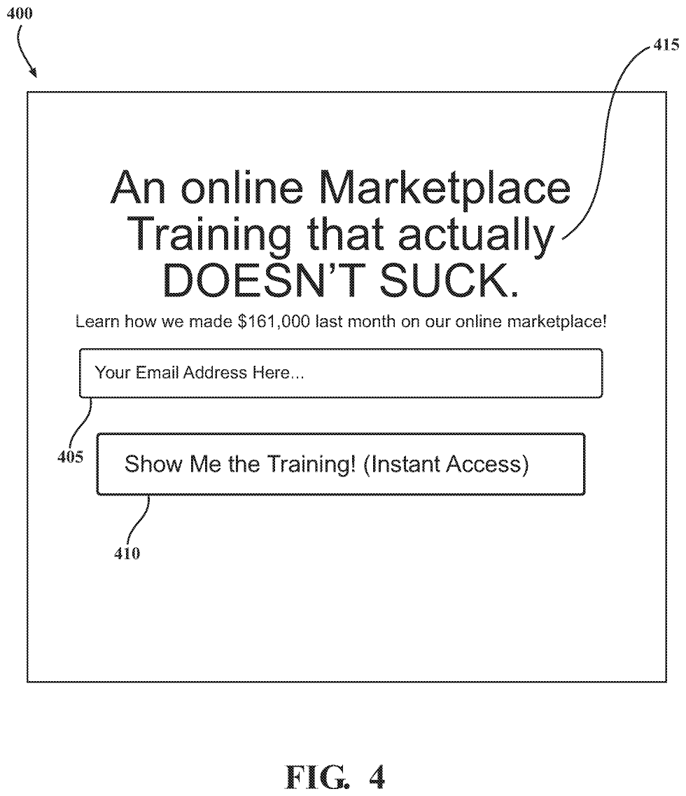

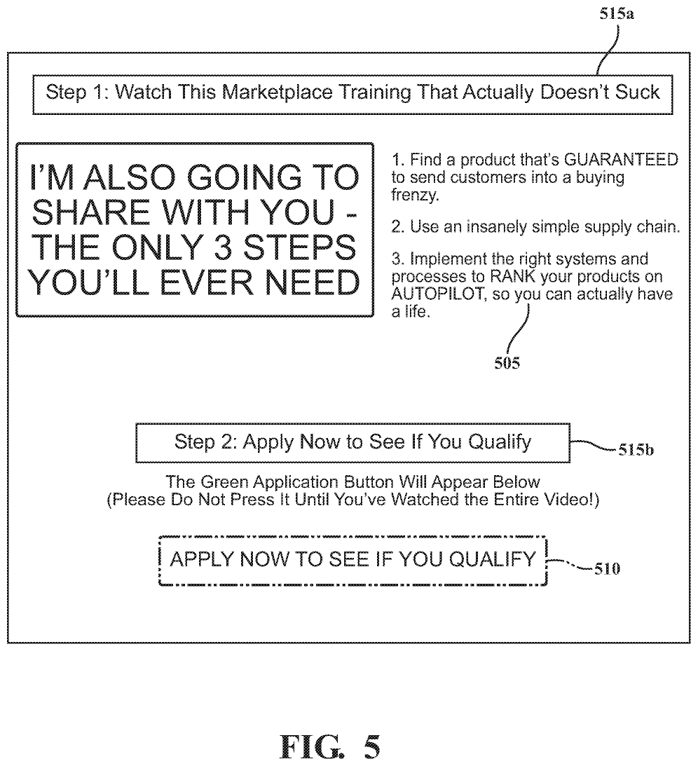

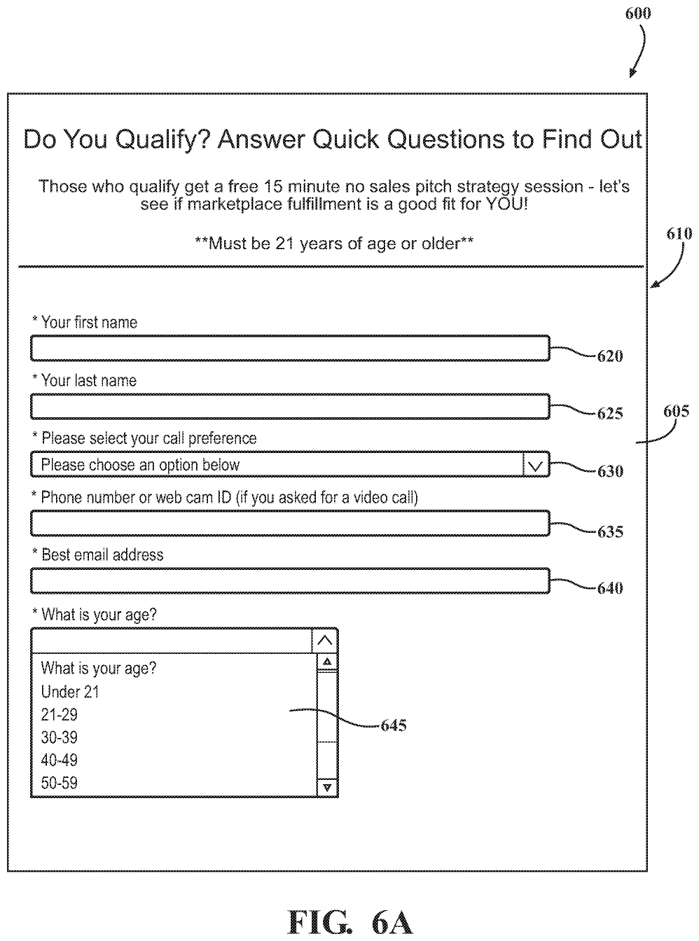

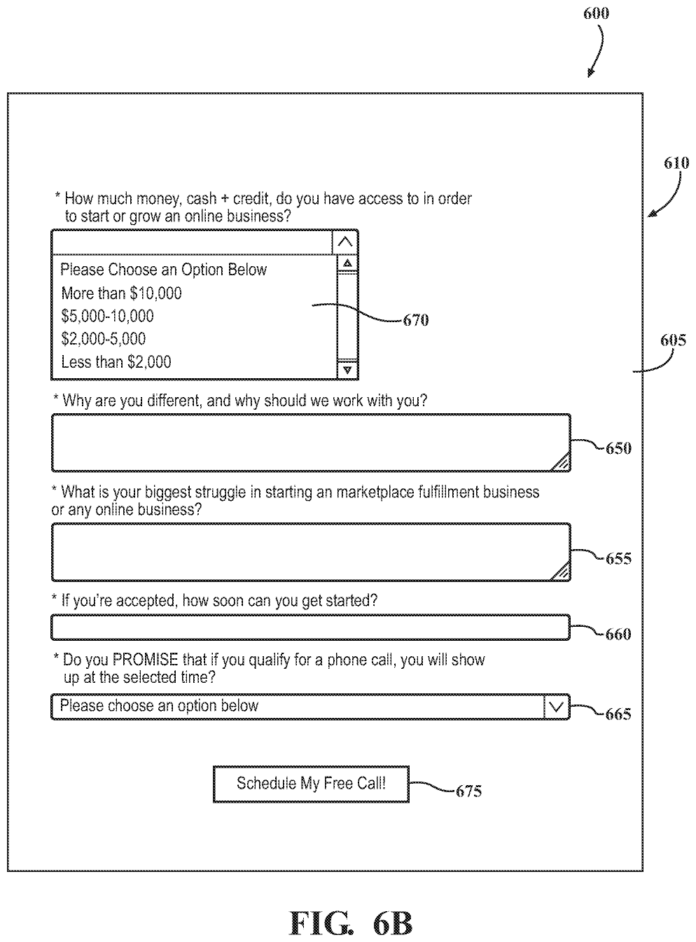

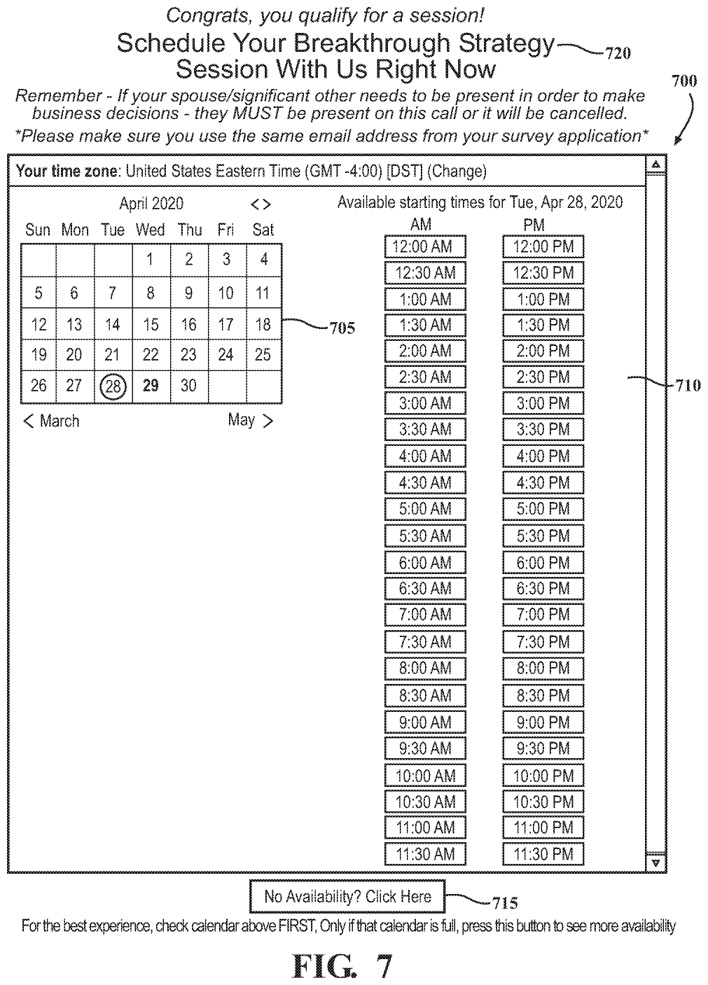

The redirection logic 244c may contain programming instructions to redirect the receiving computer (i.e., the user computing device 102a) to the various webpages (i.e., a webpage eliciting a unique identifier from a potential bonafide lead (FIG. 4), a webpage displaying a video sales letter (FIG. 5) a webpage displaying a survey questionnaire (FIGS. 6A-6B), a webpage displaying a sales call schedule (FIG. 7), and/or the like). The redirection logic 244c may also redirect potential leads to different product sales packages based on specific answers provided by the potential lead, as discussed on greater detail herein. The video sales letter logic 244d may contain programming instructions to display the video sales letter data, keep track of an elapsed time of the sales video letter, and, after a predetermined amount of time, display a graphic, such as a button, for the potential lead to click on to advance in the process. It should be appreciated that the predetermined amount of time may correspond to specific times in the video sales letter in which it is determined that the potential lead is informed of the specific sales product, there is generated interest from the potential lead, and the potential lead may continue to watch the video sales letter or advance in the process once the graphic appears and the potential lead clicks on the lead. In some embodiments, the predetermined amount of time may be after 25 percent of the video sales letter has elapsed (i.e., at the 5:00 minute marl of time elapsed if the video sales letter is 20 minutes total in length). It should also be appreciated that, in this specific example, the first 25% of the video sales letter is configured to inform the potential lead of the necessary information required to inform the potential lead of the specific sales product, to elicit the interest needed for the potential lead to advance in the process, and the like.

The survey question logic 244e may display specific survey questions to the potential lead to determine whether the potential lead qualifies as a bonafide lead for one type of specific sales package or as a bonafide lead for alternative sales packages, as discussed in greater detail herein. The survey question logic 244e may include an algorithm that, depending on the answers to the survey questions, assist the redirection logic 244c in redirecting the potential lead to the next webpage. The scheduling logic 244f may contain programming instructions to display available times for a follow-up sales call from a sales team member within a predetermined amount of time. In some embodiments, the predetermined amount of time is 30 minutes from reaching the scheduling page until 24 hours later. In other embodiments, the predetermined amount of time is 30 minutes from reaching the scheduling page until 48 hours later. It should be appreciated that the predetermined amount of time to schedule to follow-up sales call is specifically determined such that the potential lead is still interested and excited to receive the sales call and thus minimize the number of sales calls that go unanswered.

The demographic and characteristic logic 244g may contain programming instructions to determine a plurality of characteristic and/or demographic information from the potential leads who qualify as a bonafide lead such that the process is improved and such that new potential leads may be identified that have common characteristic and/or demographic as the known bonafide leads. It should be appreciated that this improves locating potential leads, converting potential leads into bonafide leads, and the like. For example, a thank you page may includes unseen pixels that, once the potential lead is on the thank you page, which means that the potential lead qualifies as a bonafide lead, initiates a code that feeds data back to the social media advertisers in order to optimize the social media advertising on those pages.

The thank you video logic 244h may contain programming instructions to determine whether the potential lead qualified as a bonafide lead and automatically plays a first video on a first thank you page or whether the potential lead qualified for an alternative sales package and is redirected to a second thank you page where a second video is automatically played. The first and second thank you pages are different as are the first and second videos. The first thank you page and the first video reinforce the sales relationship for the boanfide lead before being directed to the final thank you page where the unseen pixels and code are generated, as discussed in greater detail herein. The second video and second thank you page are intended to continue to sale the product and inform the potential lead of alternative products that may meet their specific situation (i.e., money to invest). The second video is motivation to continue and if, possible, spend more for the full product, but if not, still close the sale for an alternative sales product from the potential lead.

Further, the first and second videos are each customized or personalized to the name of the specific recipient. That is, the content of each first video is exactly the same, but the introduction which includes the name of the recipient is changed to match the name of the bonafide lead. The content of each second video is exactly the same, but the introduction which includes the name of the recipient is changed to match the name of the potential lead.

As such, the thank you video logic 244h recognizes the name of the recipient of the thank you video and variants thereof to match a saved recorded name to that of the recipient. For example, the name “Erin” may be recorded only once and used whenever the recipient of the first or second video name is “Erin”. Further variants of “Erin” are automatically determined to automatically be added to the video. Such variants may include, for example, “Erinn”, “Arryn”, “Anon”. “Aaron”, “Aron” and the like. As such, only a root name needs to be recorded one time and the system will recognize the variant and initiate the video with the prerecorded name to customize or personalize each video regardless of whether the video is the first or second thank you video.

It should be understood that the components depicted in FIG. 2A are merely illustrative and are not intended to limit the scope of this disclosure. More specifically, while the components in FIG. 2A are illustrated as residing within the interface device 102b, this is a nonlimiting example. In some embodiments, one or more of the components may reside external to the interface device 102b. Similarly, while FIG. 2A is directed to the interface device 102b, other components such as the user computing device 102a and the sales team computing device 102c may include similar hardware, software, and/or firmware.

FIG. 2B depicts the user computing device 102a further illustrating a system that interacts with the interface device 102b to identify potential leads by utilizing hardware, software, and/or firmware, according to embodiments shown and described herein. In addition, the user computing device 102a may include a non-transitory, computer readable medium configured for displaying and transmitting a data initiated by a user embodied as hardware, software, and/or firmware, according to embodiments shown and described herein.

While, in some embodiments, the user computing device 102a may be configured as a general purpose computer with the requisite hardware, software, and/or firmware, in other embodiments, the user computing device 102a may be configured as a special purpose computer designed specifically for performing the functionality described herein. For example, the user computing device 102a may be a specialized device that displays a user interface for inputting viewing a video sales letter, for clicking on a graphic, for answering a plurality of survey questions, for scheduling a sales call and/or the like, as discussed in greater detail herein.

As also illustrated in FIG. 2B, the user computing device 102a may include a processor 270, input/output hardware 272, network interface hardware 274, data storage component 276, which stores a database of selection data 278a and display data 278b, and a memory component 280. The memory component 280 may be non-transitory computer readable memory. The memory component 280 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 280 may be configured to store operating logic 282a, selection logic 282b, and display logic 282c (each of which may be embodied as a computer program, firmware, or hardware, as an example). A local interface 284 is also included in FIG. 2B and may be implemented as a bus or other interface to facilitate communication among the components of the user computing device 102a.

The processor 270 may include any processing component(s) configured to receive and execute instructions (such as from the data storage component 276 and/or memory component 280). The input/output hardware 272 may include a monitor, keyboard, mouse, printer, camera, microphone, speaker, and/or other device for receiving, sending, and/or presenting data. The network interface hardware 274 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 276 may reside local to and/or remote from the user computing device 102a and may be configured to store one or more pieces of data for access by the user computing device 102a and/or other components, store data that may be received from an external device (e.g., the interface device 102b) such as the selection data 278a, and/or store data to be displayed. As illustrated in FIG. 2B, the data storage component 276 stores a database of selection data 278a. As mentioned above, the selection data 278a may include data related to a selection such as a click ad, an answer to specific survey questions, progress of time elapsed on the video sales letter, and the like and/or data received from an external device (i.e., the interface device 102b). The display data 278b may include data relating to the data to be displayed. For instance, the display data 278b may include the order or webpages to be displayed on the user computing device 102a, such as webpages received from the interface device 102b.

Included in the memory component 280 are the operating logic 282a, selection logic 282b, and display logic 282c. The operating logic 282a may include an operating system and/or other software for managing components of the user computing device 102a. The selection logic 282b may contain programming instructions to facilitate user initiated electronic selections. The selection logic 282b may be configured to compile, organize, transmit, and/or display the user choices or selections to into an order, such that the interface device 102b may analyze the user choices and/or selections and/or such that the sales team computing device 102c may receive the user choices and/or selections. The selection logic 282b may be configured to provide data for a user interface to display or a display device of the user computing device 102a.

The display logic 282c may display a graphical user interface usable by a user of the user computing device 102a to provide choices and/or selections, to display visualizations of a plurality of metadata associated with the selected choices, and to display the result of the metadata associated with the selected choices. The display logic 282c may generally be configured to display information on a display of the user computing device 102a. The functionalities of the operating logic 282a, the selection logic 282b, and the display logic 282c will be described in further detail below.

It should be understood that the components depicted in FIG. 2B are merely illustrative and are not intended to limit the scope of this disclosure. More specifically, while the components in FIG. 2B are illustrated as residing within the user computing device 102a, this is a nonlimiting example. In some embodiments, one or more of the components may reside external to the user computing device 102a. Similarly, while FIG. 2B is directed to the user computing device 102a, other components such as the sales team computing device 102c may include similar hardware, software, and/or firmware.

FIG. 2C depicts the sales team computing device 102c further illustrating a system that interacts with the interface device 102b to identify potential leads by utilizing hardware, software, and/or firmware, according to embodiments shown and described herein. In addition, the sales team computing device 102c may include a non-transitory, computer readable medium configured for displaying and transmitting a data initiated by a user embodied as hardware, software, and/or firmware, according to embodiments shown and described herein.

While, in some embodiments, the sales team computing device 102c may be configured as a general purpose computer with the requisite hardware, software, and/or firmware, in other embodiments, the sales team computing device 102c may be configured as a special purpose computer designed specifically for performing the functionality described herein. For example, the sales team computing device 102c may be a specialized device that displays a user interface to determine selections and/or choices of a potential lead, seeing schedule information, determining a plurality of characteristic and/or demographic data, and the like, as discussed in greater detail herein.

As also illustrated in FIG. 2C, the sales team computing device 102c may include a processor 294, input/output hardware 295, network interface hardware 296, data storage component 298, which stores a database of the potential lead data 238b and the schedule data 238f, and a memory component 290. The memory component 290 may be non-transitory computer readable memory. The memory component 290 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 290 may be configured to store operating logic 292a, scheduling logic 292b, and display logic 292c (each of which may be embodied as a computer program, firmware, or hardware, as an example). A local interface 293 is also included in FIG. 2C and may be implemented as a bus or other interface to facilitate communication among the components of the sales team computing device 102c.

The processor 294 may include any processing component(s) configured to receive and execute instructions (such as from the data storage component 298 and/or memory component 290). The input/output hardware 295 may include a monitor, keyboard, mouse, printer, camera, microphone, speaker, and/or other device for receiving, sending, and/or presenting data. The network interface hardware 296 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 298 may reside local to and/or remote from the sales team computing device 102c and may be configured to store one or more pieces of data for access by the sales team computing device 102c and/or other components, store data that may be received from an external device (e.g., the interface device 102b) such as the schedule data 238f, the potential lead data 238b, and/or store data to be displayed.

As illustrated in FIG. 2C, the data storage component 298 stores the database of the potential lead data 238b and the schedule data 238f. As mentioned above, the potential lead data 238b may be data such as the unique identifier from the potential lead, may store known information from bonafide leads that may be used to identify potential leads and thus to tailor advertisements and other methods known to those skilled in the art to elicit the potential lead into the process described herein with respect to FIGS. 3A-3C, may store information concerning the particular potential lead currently using the user computing device 102a, and/or the like. Further, as mentioned above, the schedule data 238f includes user selected time period for the sales call.

Included in the memory component 290 are the operating logic 292a, scheduling logic 292b, and display logic 292c. The operating logic 282a may include an operating system and/or other software for managing components of the sales team computing device 102c. The scheduling logic 292b may contain programming instructions to facilitate the users selected schedule time and user initiated an alert to the sales team computing device 102c. As such, the scheduling logic 292b may be configured to compile, organize, transmit, and/or display the user choices or selections to into an order, such that the interface device 102b and/or the sales team computing device 102c may analyze the user choices and/or selections and/or such that the sales team computing device 102c may receive the user choices and/or selections. The scheduling logic 292b may be configured to provide data for a user interface to display or a display device of the sales team computing device 102c.

The display logic 292c may display a graphical user interface usable by a user of the sales team computing device 102c to provide choices and/or selections, to display visualizations of a plurality of metadata associated with the selected choices, and to display the result of the metadata associated with the selected choices. The display logic 292c may generally be configured to display information on a display of the sales team computing device 102c. The functionalities of the operating logic 292a, the scheduling logic 292b, and the display logic 292c will be described in further detail below.

It should be understood that the components depicted in FIG. 2C are merely illustrative and are not intended to limit the scope of this disclosure. More specifically, while the components in FIG. 2C are illustrated as residing within the sales team computing device 102c, this is a nonlimiting example. In some embodiments, one or more of the components may reside external to the sales team computing device 102c. Similarly, while FIG. 2C is directed to the sales team computing device 102c, other components such as the user computing device 102a may include similar hardware, software, and/or firmware.

Referring now to FIGS. 3A-3B, a flow diagram that graphically depicts an illustrative method 300 of identifying a bonafide lead is provided. Although the steps associated with the blocks of FIGS. 3A-3B will be described as being separate tasks, in other embodiments, the blocks may be combined or omitted. Further, while the steps associated with the blocks of FIGS. 3A-3B will described as being performed in a particular order, in other embodiments, the steps may be performed in a different order.

As shown in FIG. 3A, the method 300 may begin with paid social media advertising, at block 302, that entices potential clients to select on the ad at block 304, which then redirects the potential customers onto a landing page, at block 306. Should the user not select the advertisement at block 304 then it should be appreciated that the method 300 continuously loops between blocks 302, 304. In some embodiments, the paid social media advertising may be short advertisements (e.g. 3-10 minutes). Further, in some embodiments, these advertisements may be either a direct call to action or a helpful, but no specific call to action. The direct call to action may be ads that specifically ask a customer to sign up for a free training, such as training on Fulfillment by Amazon (FBA), as discussed in greater detail herein. The helpful, but with no specific call to action may be ads that teach people about general topics, such as online marketplace selling. It should be appreciated that the content of the ads may be tailored to comply with rules and regulations of the social media platforms.

On the landing page a query is displayed eliciting a unique identifier from the user at block 308. That is, the potential lead is asked to opt in to receive a free training video, and, to opt in, the potential lead provides the unique identifier, such as a phone number, a name, an email address, and the like. Once opted in, at block 310 the user computing device and the user are directed to a video sales letter page, which includes a video sales letter. It should be understood that the directing of the user computer device to the video sales letter page at block 310 is a video sales letter funnel. At block 312 the video sales letter page plays a video tailored to convince a potential lead to purchase the product or service. The video is tailored to convince a potential lead to continue in the process to potentially purchase a specific product, such as specific training curriculum for on-lines sales. In a non-limiting example, the training curriculum may include training related to FBA. The video may vary in length and generally is there to explain the products to the potential customer as well as explain why this particular product is superior to other products. In a non-limiting example, the video length may be 25 minutes long.

It should be appreciated that the video sales letter video may have to be presented to potential customers in a way that convinces potential customers at a high percentage, to remain interested and learn from what is being presented. Further, the video sales letter video has to present information to the potential lead so that the potential lead will continue in the process by clicking a graphic, filling out a survey, scheduling a call, showing up to that call, and the like, as discussed in greater detail herein.

The landing page further includes a delayed graphic, such as an “application button” that has a predetermined time before the delayed graphic appears for the user to advance in the method 300. As such, the system determines whether the predetermined amount of time has elapsed in the video sales letter video, at block 314, before permitting the graphic to appear at block 316. That is, the graphic does not appear at block 316 until after the predetermined time has elapsed, at block 314. As such, the method 300 loops between blocks 314 and 316 until the predetermined amount of time has lapsed. In a non-limiting example, the delayed graphic may not appear for the potential lead to advance in the illustrative method 300 until at least 25% of the video has elapsed. In other embodiments, the delayed graphic may appear, at block 316, before 25% of the video has elapsed or may not appear until sometime after 25% of the video has elapsed. In this embodiment, the 25% mark has been determined as the exact point in which the message from the video sales letter video entices the potential lead to proceed further in the illustrate method 300. As such, the delayed graphic is used for lead quality, that the potential lead has interest, and is educated about the product or service at least until the predetermined time of the video elapsing.

That is, potential leads may get click happy, click the button, schedule a call, and/or are unprepared to move forward because the potential customer has not digested enough of the content. On the other hand, if the delay of the graphic is too long, potential leads may get bored or distracted and click off the page, never schedule a call, and never become a bonafide lead.

At block 318, the system determines whether the potential lead selected the graphic. It should be understood that the video sales letter video may continue to play while the delayed graphic is displayed (i.e., now appeared) and thus the illustrative method loops between blocks 316 and 318 until the potential lead selects the graphic at block 318. Once the potential lead selects the delayed graphic, at block 318, the potential lead and the user computing device is directed to a survey page, at block 320, the survey is displayed at block 322, and queries at least an age of the user at block 324 and whether the potential lead has more than $2,000 available to invest, at block 326.

In some embodiments, more than or less than two survey questions may be presented to the potential lead. In some embodiments, the survey questions are presented to the potential lead using known software interaction and programs. It should be appreciated that the potential lead may be asked to select an age range at block 328 and/or a range of money that the potential lead has access to for starting an FBA business. In a non-limiting example, the question may ask the potential lead “If you were 100% on starting an FBA business, how much money could you have access too?” The predetermined ranges for the second question are 1) more than $10,000; 2) $5,000-$10,000; 3) $2,000-$5,000 and 4) less than $2,000. It should be appreciated that the questions and/or ranges are specifically tailored to the tiers of programs that are for sale and are used to determine whether the potential customer is qualified or a bonafide lead, (i.e., over 21 and with more than $2,000 to spend). As such, this improves the lead generation to ensure that future potential leads may qualify as bonafide leads.

If the potential lead is under 21 years of age, at block 328, and/or does not have at least $2,000 to invest, at block 330, the user is directed to an illustrative method 380 (FIG. 3C) and the illustrative method 300 ends. If the potential lead is over 21 years of age, at block 328, and has at least $2,000 to invest, at block 330, the user computing device and the potential lead is directed to a plurality of sales packages, at block 332 and a schedule of available conference call times is displayed for the potential lead to select an availability within a predetermined amount of time, at block 334. The potential lead selects the available conference call time, at block 336, which is stored and transmitted to the sales team computing device and/or the interface device, at block 338, and the user computing device and potential lead is redirected to a first thank you page, at block 340.

That is, if the potential lead does qualify, (i.e., over 21 years old and has the minimum amount of money to invest), the potential lead is redirected to the scheduling page, at block 334 to schedule a conference call with a sales member, at block 336. The scheduler only permits predetermined windows of booking, such as, for example, 30 minutes from the time the potential lead is on the scheduler page up to 24 hours later. It should be appreciated that the predetermined windows of booking within the scheduler may be greater than 24 hours. This book window time has been identified as the highest show up rates and overall highest return on investment for this particular sales product. That is, if the potential customer books any later, or further out, there is a greater likelihood that the potential customer will not show up for the sales call.

At block 342, the potential lead is sent a customized first video to display on the first thank you page. The first video may be customized or personalized video from a member of the sales management team and calls the potential lead by their first name. For example, the first video may be a congratulatory video with the CEO of the company personally addressing the name of the potential lead. Further, the first thank you page may include a plurality of marketing materials for the potential lead to review prior to the initial sales call. Once the video is complete, the user computing device and potential lead is redirected to a tracking thank you page, at block 344. The tracking thank you page includes unseen pixels that, once the potential lead is on the tracing thank you page, initiates a code that feeds data back to the social media advertisers in order to optimize the social media advertising on those pages. That is, known characteristics and demographics of the potential leads who make it this far in the illustrative method 300 are tracked, at block 346 and are utilized to target a plurality of potential leads using the known predetermined demographic and/or characteristic information about the current potential lead, at block 348, to improve ads displayed to those types of users on social media platforms, as discussed in greater detail herein. The now bonafide lead is then contacted by the sales team member at block 350.

Once the potential lead selects an availability for the sales call at block 336, the availability of the potential lead is stored and transferred to the sales team member computer device and/or the interface device such that a sales team is notified of the availability of the potential lead, at block 352. The system determines whether more than one sales team member is available during the potential lead's selected availability time, at block 354. If only one sales person is available, at block 354, then the only available sales person is assigned the call, at block 356 and the sales team member calls the potential lead at block 360.

If the system determines that more than one sales team member is available during the potential lead's selected availability time, at block 354, then the system assigns an available sales team member based on a sales team member ranking, at block 358. For example, internal sales rankings may be based on predetermined factors such as the closing rate and the like. That is, if two sales people are available at the same time that the potential lead scheduled the call, at block 336, the sales person with the higher ranking will automatically be scheduled for the call, at block 358. The sales team member calls the potential lead at block 360.

It should be appreciated that the potential lead's answers to the survey questions and other demographic and/or characteristic information is transferred to the selected team member, based on availability and/or an internal ranking. It should also be appreciated that the delayed graphic, at block 314 and the survey questions and responses, at blocks 322-332, improve the lead quality of the potential leads. Further, it should be appreciated that the delay graphic at block 314 and the survey questions and responses, at blocks 322-332, allows the paid social media advertising to become smarter over time through artificial intelligence and machine learning. That is, because the social media platforms are optimized for an end goal, such as a booked call with a salesperson, the social media platforms optimize for those types of potential leads with more than the predetermined amount of money to invest. Further, known areas (i.e., U.S., different states, regions, other countries, and the like), demographics, and characteristics of potential leads, based on IP addresses, allows the paid social media advertising to target those potential leads and target less of a plurality of generic leads whose known area, demographics, and characteristics are generally less desirable to generating the bonafide lead. As such, the paid social media advertising becomes smarter and more selective.

Now referring to FIG. 3C, a flow diagram that graphically depicts the illustrative method 380 of, in one embodiment, directing the potential lead to an alternative sales package is provided. Although the steps associated with the blocks of FIG. 3C will be described as being separate tasks, in other embodiments, the blocks may be combined or omitted. Further, while the steps associated with the block of FIG. 3C will described as being performed in a particular order, in other embodiments, the steps may be performed in a different order.

If the potential lead is not over 21, at block 328 (FIG. 3A), and/or if the potential lead does not have the minimum requirement of money to invest at block 330 (FIG. 3A), then the potential lead is directed to an alternative plurality of sales packages, at block 385, such as a bootcamp funnel, and the plurality of alternative plurality of sales packages are displayed at block 390. The bootcamp funnel allows potential customers a much cheaper alternative to the specific product sales associated with the illustrative method 300. That is, potential customers may get a cheaper trial period to allow the potential lead to determine whether to spend more money to get the full curriculum, purchase smaller upgrades, and the like. Further, in the bootcamp funnel, the data provided by the potential customer may be stored in the database of the interface device and the information may be transmitted or shipped to third party companies who pay for the lead generation.

At block 395, the system determines whether the potential lead has selected an alternative sales package. If the potential lead does not select an alternative sales pack, the illustrative method 380 ends at 397. If the potential lead selects an alternative sales pack, at block 395, then the potential lead may be contacted by a member of the sales team, at block 354. It should be appreciated that the potential may not necessarily contacted by the sales team member and is instead enrolled into a particular sales curriculum where communication is via e-mail or some other means other than a direct phone call.

Now referring to FIG. 3D, in another embodiment a flow diagram that graphically depicts the illustrative method 361 of directing the potential lead to an alternative sales package is provided. Although the steps associated with the blocks of FIG. 3D will be described as being separate tasks, in other embodiments, the blocks may be combined or omitted. Further, while the steps associated with the block of FIG. 3D will described as being performed in a particular order, in other embodiments, the steps may be performed in a different order.

If the potential lead is not over 21, at block 328 (FIG. 3A), and/or if the potential lead does not have the minimum requirement of money to invest at block 330 (FIG. 3A), then the potential lead is directed to an alternative plurality of sales packages, at block 362, such as a bootcamp funnel. The bootcamp funnel may allow potential leads a much cheaper alternative to the specific product sales associated with the illustrative method 300. That is, potential customers may get a cheaper trial period to allow the potential lead to determine whether to spend more money to get the full curriculum, purchase smaller upgrades, and the like. Further, in the bootcamp funnel, the data provided by the potential customer may be stored in the database of the interface device and the information may be transmitted or shipped to third party companies who pay for the lead generation.

At block 364, the potential lead is directed to a schedule of available conference call times, which are displayed for the potential lead to select an availability within a predetermined amount of time. The potential lead selects the available conference call time, at block 366, which is stored and transmitted to the sales team computing device and/or the interface device, at block 338, and the user computing device and potential lead is redirected to a second thank you page, at block 368. In some embodiments, the scheduler only permits predetermined windows of booking, such as, for example, 30 minutes from the time the potential lead is on the scheduler page up to 24 hours later. It should be appreciated that the predetermined windows of booking within the scheduler may be greater than 24 hours. This book window time has been identified as the highest show up rates and overall highest return on investment for this particular sales product. That is, if the potential customer books any later, or further out, there is a greater likelihood that the potential customer will not show up for the sales call.

At block 370, the potential lead is sent at least one customized second video to display on the second thank you page. The at least one second video may be customized or personalized video from a member of the sales management team and calls the potential lead by their first name. For example, the at least one second video may be a video with the CEO of the company personally addressing the name of the potential lead and discussing options moving forward in an attempt to close a sale with the original sales product and/or one of the alternative sales product display in the bootcamp funnel. Further, the second thank you page may include a plurality of marketing materials for the potential lead to review prior to the initial sales call. Once the second video is complete, the illustrative method 361 ends at 372.

Referring now to FIG. 4, an illustrative view of a landing webpage 400 eliciting the unique identifier from the potential lead is schematically depicted. The landing webpage 400 includes a query field 405 and a graphic 410 to advance. The query field includes a input box in which the potential lead may input the unique identifier, such as an e-mail address. In some embodiments, the landing webpage 400 may further include a language or graphic display area 415 to entice the potential leads to continue on the process.

Referring now to FIG. 5, an illustrative view of a video sales letter webpage 500 is schematically depicted. The video sales letter webpage 500 includes a video player 505 configured to play the video sales letter and a delayed graphic, such as an application button 510, that appears to the potential lead only after a predetermined amount of time has elapsed in the playing of the video sales letter. In some embodiments, the video sales letter webpage 500 may further include a language or graphic display area 515a, 515b to entice the potential leads to continue on the process.

Referring now to FIGS. 6A-6B, an illustrative view of a survey webpage 600 is schematically depicted. FIG. 6A schematically depicts an illustrative view of the survey webpage 600 displaying a first portion 605 of a survey questionnaire 610 and FIG. 6B schematically depicts an illustrative view of the survey webpage 600 displaying a second portion 615 of the survey questionnaire 610. The first portion 605 of the survey questionnaire 610 includes a plurality of input fields for the potential lead to complete, such as, a first name 620, last name 625, select call preference 630, phone number and/or web cam id 635, and/or email address 640. Further, the first portion 605 of the survey questionnaire 610 may include a selection age range field 645 in which the potential lead selects an age range.

The second portion 615 of the survey questionnaire 610 includes a plurality of input fields for the potential lead to complete, such as, an input field for the potential lead to explain why they are different field 650, biggest struggle in starting a marketplace fulfillment business or any online business field 655, how soon can you start field 660, and/or a promise to show up at a selected time for a sales call field 665. Further, the second portion 615 of the survey questionnaire 610 may include a selection field for how much cash and credit does the potential lead have access to in order to start or grow an online business field 670. The survey webpage 600 further includes a graphic to advance and schedule a sales call. It should be appreciated that the survey webpage 600 and/or the survey questionnaire may add or delete fields, change the questions for the potential lead to complete, reorder the fields and/or selectable ranges, and the like.

Referring now to FIG. 7, an illustrative view of a scheduling webpage 700 providing a predetermined timeframe for the potential lead to schedule a sales call from a sales team member is schematically depicted. The scheduling webpage 700 includes a calendar field 705 and a time slot field 710 that only allow the potential user to select a schedule time for the sales call during a predetermined timeframe. For example, in some embodiments, the predetermined timeframe is a range between 30 minutes from accessing the scheduling webpage 700 until 24 hours later. In other embodiments, the predetermined timeframe may be a range from 30 minutes from accessing the scheduling webpage 700 until 48 hours later. It should be appreciated that the predetermined timeframe is intentionally established to ensure that the potential lead still has interest in the particular sales product when the sales team member makes the sales call so to minimize the chances of the potential lead from not showing up for the sales call. It should be understood that the sales call during the predetermined timeframe may be one of a teleconference call, a text message, an email message, a notification, and a social media network message. In some embodiments, the scheduling webpage 700 may further include a language or graphic display area 720 to instruct the potential lead and a no availability graphic 715 to offer an alternative schedule time.

It should be appreciated that the disclosed systems and methods are configured to identify potential bonafide leads for a particular sales product. More specifically, the disclosed systems and methods provide an approach to identify potential leads by educating the potential lead on the particular sales product via a video sales letter and at a predetermined elapsed time, allow the potential lead to advance to a survey. The survey assists in determining whether the potential lead meets at least two qualifications that have been selected to maximize the odds that the potential lead will turn into a bonafide lead. Moreover, the disclosed systems and methods transmit data, based on potential leads that may qualify as a bonafide lead, such as characteristic data and demographic data, to improve locating additional potential leads based on similar data. Furthermore, the disclosed systems and methods employ a novel or unconventional approach to mine for potential leads and determine whether the potential lead is a bonafide lead.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for determining a bonafide lead, the method comprising:
displaying an advertisement on a third party webpage;
receiving, from a user client device, a selection of a type of first response action from a user,
directing the user client device to a first webpage based on the first type of response action received from the user;
querying a unique identifier from the user;
playing a video sales letter directed to the user;
displaying a graphic to appear to the user after a predetermined amount of time of the playing of the video sales letter directed to the user has elapsed and before the video sales letter has ended;
activating, by the user, the graphic;
directing the user client device to a second webpage based on the activating of the graphic by the user;
querying, via a first survey question, a second type of response action;
querying, via a second survey question, a third type of response action;
directing the user client device to a third webpage based on the second and third type of response actions received from the user, wherein the third webpage receives a qualified user to display a first plurality of sales packages and to elicit a teleconference with a sales representative;
scheduling the teleconference with the sales representative within a predetermined time frame based on a time when the user client device is directed to the third webpage; and
directing the user client device to a fourth webpage after the qualified user has scheduled the teleconference with the sales representative,
wherein, the fourth webpage includes a plurality of hidden pixels that track the qualified user and a plurality of predetermined demographic and characteristics information about the qualified user such that the advertisement on the third party webpage may target a plurality of target potential users with similar demographic and characteristics at a future point in time.

2. The method of claim 1, wherein the first survey question asks whether the user is older than 21 years of age.

3. The method of claim 2, wherein the second survey question asks whether the user is the user has more than two thousand dollars to invest.

4. The method of claim 1, further comprising the step of directing the user client device to a fifth webpage based on the second and third type response actions received from the user following the step of querying, via the second survey question, the third type of response action.

5. The method of claim 4, wherein the fifth webpage receives a nonqualified user to offer a second plurality of sales packages different from the first plurality of sales packages.

6. The method of claim 5, wherein the unique identifier, the second type of response action and the third type of response action data of the nonqualified user is shared with a plurality of third party companies.

7. The method of claim 1, wherein the third party webpage is a social media network.

8. The method of claim 1, wherein the predetermined amount of time before displaying the graphic to appear to the user is 25 percent of the video sales letter elapsed.

9. The method of claim 1, wherein the predetermined time frame for scheduling the teleconference with the sales representative ranges between 30 minutes and 24 hours.

10. The method of claim 1, wherein the advertisement on the third party webpage is a direct call to action ad that ask the user to sign up for a free training.

11. The method of claim 1, wherein the advertisement on the third party webpage is teaches the user about general topics.

12. The method of claim 1, further comprising the steps of:
notifying a sales team of the scheduled teleconference with the user;
transferring the unique identifier, the second type of response action and the third type of response action to an available sales team member,
wherein the available sales team member is determined based on an availability of a plurality of sales team members and a plurality of internal metrics that rank each sales team member of the plurality of sales team members with availability during the scheduled teleconference.

13. The method of claim 12, wherein the scheduled teleconference includes at least one of a teleconference call, a text message, an email message, a notification, and a social media network message.

14. The method of claim 1, wherein the plurality of predetermined demographic and characteristics information about the qualified user includes a current residing region of the qualified user.

15. The method of claim 14, wherein the plurality of predetermined demographic and characteristics information about the qualified user includes tracking an IP address of the qualified user to target a similar IP address in a similar residing regions.

16. A system for determining a bonafide lead comprising:
a processing device; and
a non-transitory, processor-readable storage medium in communication with the processing device, the non-transitory, processor-readable storage medium comprising one or more programming instructions that, when executed, cause the processing device to:
display, on a user client device, an advertisement on a third party webpage;
receive, from the user client device, a selection of a type of first response action from a user;
direct, the user client device, to a first webpage based on the first type of response action received from the user;
query, on the user client device, a unique identifier from the user;
play, on the user client device, a video sales letter directed to the user;
display, on the user client device, a graphic to appear to the user after a predetermined amount of time of the playing of the video sales letter directed to the user has elapsed and before the video sales letter has ended;
activate, by the user on the user client device, the graphic;
direct the user client device to a second webpage based on the activating of the graphic by the user;
query, via a first survey question, a second type of response action;
query, via a second survey question, a third type of response action;
direct the user client device to a third webpage based on the second and third type response actions received from the user, wherein the third webpage receives a qualified user to display a first plurality of sales packages and to elicit a teleconference with a sales representative;
schedule the teleconference with the sales representative within a predetermined time frame based on a time when the user client device is directed to the third webpage; and
direct the user client device to a fourth webpage after the user has scheduled teleconference with the sales representative,
wherein, the fourth webpage includes a plurality of hidden pixels that track the user and a plurality of predetermined demographic and characteristics information about the user such that the advertisement on the third party webpage may target a plurality of target potential users with similar demographic and characteristics at a future point in time.

17. The system of claim 16, wherein the first survey question asks whether the user is older than 21 years of age.

18. The system of claim 17, wherein the second survey question asks whether the user is the user has more than two thousand dollars to invest.

19. The system of claim 16, wherein the non-transitory, processor-readable storage medium further comprising one or more programming instructions that, when executed, cause the processing device to:
direct the user client device to a fifth webpage based on the second and third type response actions received from the user following the step of querying, via the second survey question, the third type of response action.

20. The system of claim 19, wherein the fifth webpage receives a nonqualified user to offer a second plurality of sales packages different from the first plurality of sales packages.

21. The system of claim 20, wherein the unique identifier, the second type of response action and the third type of response action data of the nonqualified user is shared with a plurality of third party companies.

22. The system of claim 16, wherein the third party webpage is a social media network.

23. The system of claim 16, wherein the predetermined amount of time before displaying the graphic to appear to the user is 25 percent of the video sales letter elapsed.

24. The system of claim 16, wherein the predetermined time frame for scheduling the teleconference with the sales representative ranges between 30 minutes and 24 hours.

25. The system of claim 16, wherein the non-transitory, processor-readable storage medium further comprising one or more programming instructions that, when executed, cause the processing device to:
notify, by an interface device, a sales team of the scheduled teleconference with the user;
transfer, by the interface device, the unique identifier, the second type of response action and the third type of response action to an available sales team member,
wherein the available sales team member is determined based on an availability of a plurality of sales team members and a plurality of internal metrics that rank each sales team member of the plurality of sales team members with availability during the scheduled teleconference.

26. The system of claim 25, wherein the scheduled teleconference includes at least one of a teleconference call, a text message, an email message, a notification, and a social media network message.

27. The system of claim 16, wherein the plurality of predetermined demographic and characteristics information about the user includes a current residing region of the qualified user.

28. The system of claim 27, wherein the plurality of predetermined demographic and characteristics information about the user includes tracking an IP address of the qualified user to target a similar IP address in a similar residing regions.

29. A method for determining a bonafide lead comprising:
displaying an advertisement on a third party webpage;
receiving, from a user client device, a selection of a type of first response action from a user,
directing the user client device to a first webpage based on the first type of response action received from the user;
querying a unique identifier from the user;
playing a video sales letter directed to the user;
displaying a graphic to appear to the user after a predetermined amount of time of the playing of the video sales letter directed to the user has elapsed and before the video sales letter has ended;
activating, by the user, the graphic;
directing the user client device to a second webpage based on the activating of the graphic by the user;
querying, via a first survey question, a second type of response action;
querying, via a second survey question, a third type of response action;
determining whether the second and third type response actions received from the user meet a predetermined threshold;
directing the user client device to a third webpage based on the second and third type response actions received from the user meet the predetermined threshold, wherein the third webpage receives a qualified user to display a first plurality of sales packages and to elicit a teleconference with a sales representative;
scheduling the teleconference with the sales representative within a predetermined time frame based on a time when the user client device is directed to the third webpage;
directing the user client device to a fourth webpage after the qualified user has scheduled the teleconference with the sales representative, wherein the fourth webpage includes a customized video for the qualified user; and
directing the user client device to a fifth webpage after the qualified user has completed the customized video, wherein, the fifth webpage includes a plurality of hidden pixels that track the qualified user and a plurality of predetermined demographic and characteristics information about the qualified user such that the advertisement on the third party webpage may target a plurality of target potential users with similar demographic and characteristics at a future point in time.

30. The method of claim 29, further comprising:
directing the user client device to a sixth webpage based on the second and third type response actions received from the user do not meet the predetermined threshold, wherein the sixth webpage receives an alternative sales user to display a second plurality of sales packages and to elicit the teleconference with the sales representative, the second plurality of sales packages are different from the first plurality of sales packages;
scheduling an alternative communication with the sales representative within the predetermined time frame based on the time when the user client device is directed to the sixth webpage; and
directing the user client device to a seventh webpage after the alternative sales user has scheduled the teleconference with the sales representative, wherein the seventh webpage includes a customized video for the alternative sales user.
